(19) United States
(12) Patent Application Publication
(10) Pub. No.: US 2004/0114385 A1
(43) Pub. Date: Jun. 17, 2004

(54) Illuminating apparatus for exhaust tail pipe

(76) Inventor: Jui-Sheng Ho, Dali City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/320,442

(22) Filed: Dec. 17, 2002

(51) Int. Cl. B60Q 1/00

(52) U.S. Cl. 362/500; 362/545; 362/549

(57) ABSTRACT

An illuminating apparatus for an exhaust tail pipe and particularly an exhaust tail pipe equipped with an illuminating apparatus to provide an alarming effect mainly has a lighting means screwed on the tail end of the exhaust tail pipe. The lighting means has a body housing a holding dock to hold an axle of a lighting wheel which has fan blades located thereon. When the vehicle is moving, discharged exhaust gas flow drives the fan blades to rotate and consequently drives a polar plate located in a low speed generator in the light means to rotate relative to a stationary magnet coupled on the axle to generate electric power to light LED lamps connected to the polar plate. Thus a rotating lighting ring is formed to alert the rear vehicles.

### BACKGROUND OF THE INVENTION

1. Field of the Invention

The invention relates to an illuminating apparatus for an exhaust tail pipe and particularly to an exhaust tail pipe that equips with an illuminating apparatus to provide an alarming effect.

2. Description of the Prior Art

The general exhaust tail pipes merely provide channels for cars and motorcycles to discharge exhaust gas. They do not have other functions. The cars and motorcycles have brake lights to alarm the vehicles in the rear during driving. The brake lights generate light only when the brakes are actuated. It would be more desirable to provide an alarm device that can generate warning light without an extra power supply and is operable while the vehicle is moving.

### SUMMARY OF THE INVENTION

The primary object of the invention is to provide an illuminating apparatus for an exhaust tail pipe to enhance alert effect.

Another object of the invention is to provide an illuminating apparatus for an exhaust tail pipe that does not need an extra power supply and is operable by driving a lighting wheel to rotate through discharging exhaust gas through the exhaust tail pipe.

Yet another object of the invention is to provide an illuminating apparatus for an exhaust tail pipe that enables users to do installation easily by themselves without damaging the structure of the exhaust tail pipe.

The illuminating apparatus according to the invention may be screwed and fastened to the exhaust tail pipe by users in a DIY (Do-It-Yourself) manner. The exhaust gas flow drives and rotates air fan blades, and consequently drives a lighting wheel to rotate to generate light.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of the invention.

FIG. 2 is a perspective view of the invention.

FIG. 3 is a sectional view of the invention.

FIG. 4 is an exploded view of the invention coupled with an exhaust tail pipe.

FIG. 5 is a perspective view of the invention coupled with an exhaust tail pipe.

FIG. 6 is a sectional view of the invention coupled with an exhaust tail pipe.

### DESCRIPTION OF THE PREFERRED EMBODIMENT

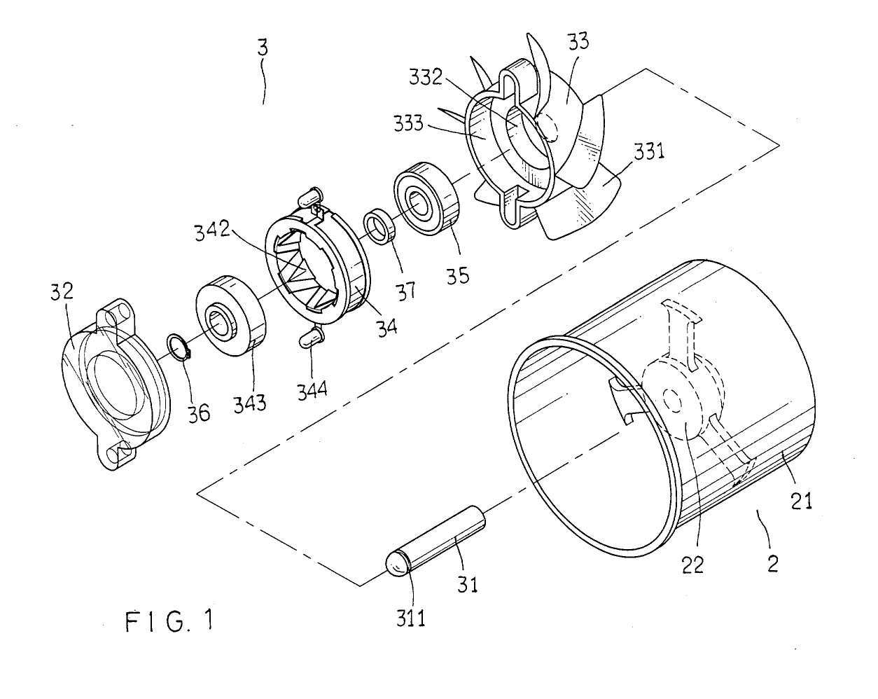

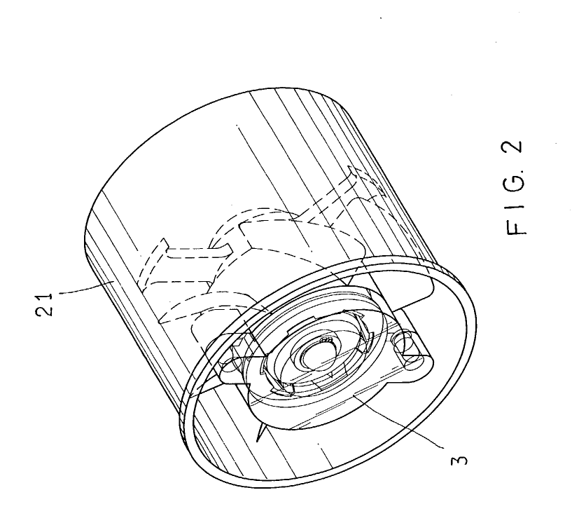

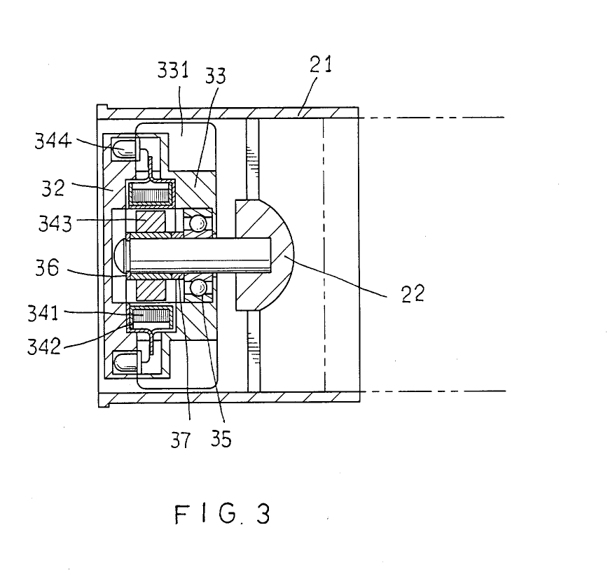

Referring to FIGS. 1, 2 and 3, the illuminating apparatus of the invention mainly includes a lighting means 2 fastened to the tail end of an exhaust tail pipe 1. The lighting means 2 has a body 21 which has one end connecting to the exhaust tail pipe 1. The body 21 has a holding dock 22 located therein to couple with an axle 31 of a lighting wheel 3.

One end of the axle 31 of the lighting wheel 3 is fixedly engaged with the holding dock 22 in the body 21. The axle 31 is coupled with a left hub 32 and a right hub 33. The right hub 33 houses a low speed generator 34. The low speed generator 34 includes a coil 341 which is covered from outside by a polar plate 342. The polar plate 342 has a peripheral rim connecting to a plurality of LED lamps 344. The low speed generator 34 further has a magnet 343 located therein to couple with the axle 31. The right hub 33 has an outer peripheral rim connecting to fan blades 331 and an inner peripheral rim forming a first housing compartment 332 for holding a bearing 35 and a second housing compartment 333 for holding the low speed generator 34 and the LED lamps 344 located on the polar plate 342. Then a C-shaped clip washer 36 is clipped the axle 31 to anchor the magnet 343 on the axle 31. The left hub 32 is made from a transparent material (such as acrylic or plastics) and is fastened to the right hub 33.

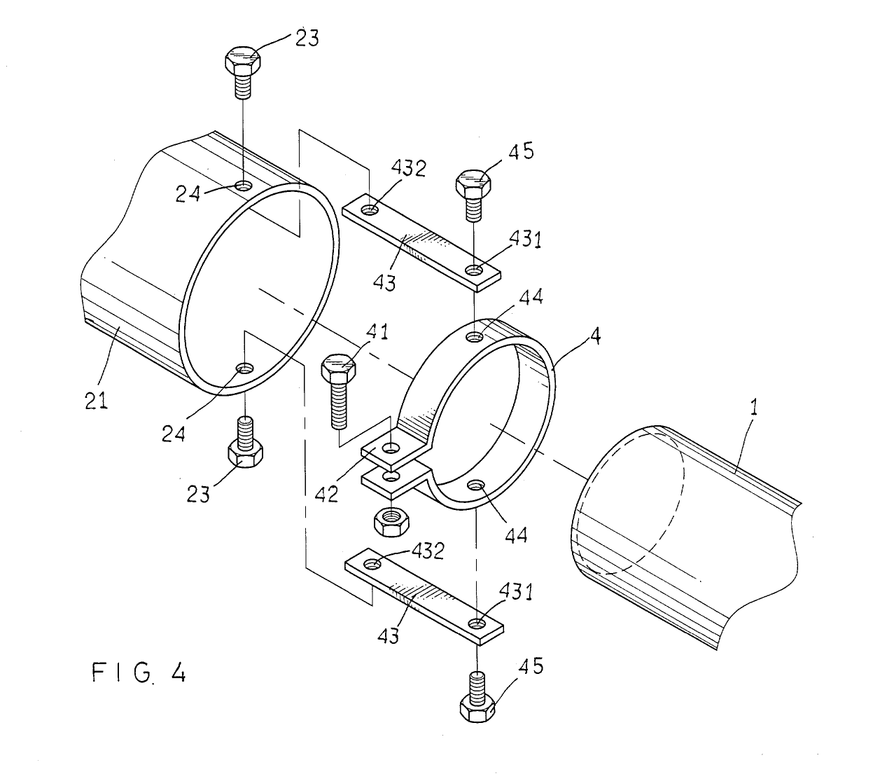

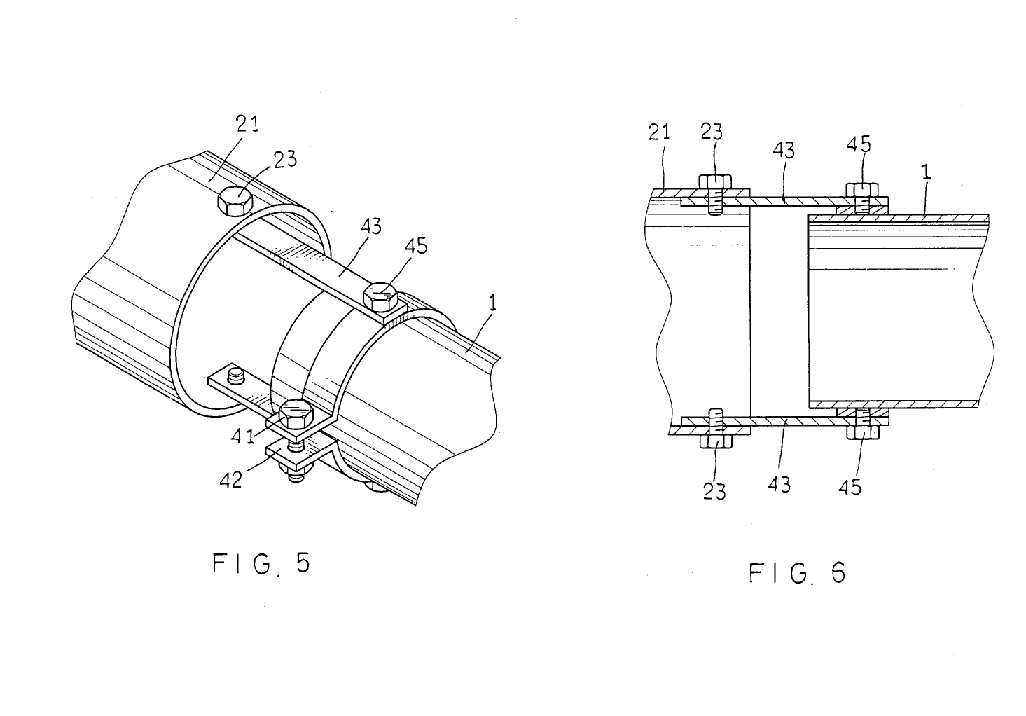

Refer to FIGS. 4 and 5 for the invention fastening to the exhaust tail pipe 1. A pipe clip 4 is provided to clamp the exhaust tail pipe 1 tightly by a screw 41 through a flap 42 extending sidewards from the pipe clip 4. The pipe clip 4 has an anchor hole 44 to engage with a screw 45 for fastening to a screw hole 431 formed on one end of a connection beam 43. The connection beam 43 has another screw hole 432 formed on another end thereof to engage with another screw 23 for fastening to a screw hole 24 formed on the body 21 of the lighting means 2.

For assembly of the invention, the axle 31 of the lighting means 2 is fixedly fastened to the holding dock 22. Next, the right hub 33 with the fan blades 31 located thereon is coupled on the axle 31; then the bearing 35 is coupled on the axle 31 and held firmly in the first housing compartment 332 of the right hub 33. Then the low speed generator 34 is disposed in the right hub 33. Thereafter, a bushing 37 and the magnet 343 of the low speed generator 34 are coupled on the axle 31 in this order. Then the C-shaped clip washer 36 is coupled on a clipping groove 311 formed on the axle 31 to retain the forging elements in place. Finally, the left hub 32 is coupled on the axle 31 and fastened to the right hub 33. The lighting means 2 thus completed is screwed on the pipe clip 4 and fastened to the exhaust tail pipe 1 through the connection beam 43. By means of the construction set forth above, when the car or motorcycle is driving, exhaust gas flow discharged from the exhaust tail pipe 1 drives the fan blades 331 of the lighting wheel 3 to rotate. As a result, the polar plate 342 on the low speed generator 34 also is driven to rotate relative to the stationary magnet 343 coupled on the axle 31, and a magnetic energy is generated to enable the coil 341 to generate electric power. Thus the LED lamps 344 connecting to the polar plate 342 are lighted. The rotating light produced by the LED lamps 344 may provide an alert effect to the rear vehicles.

While the preferred embodiment of the invention has been set forth for the purpose of disclosure, modifications of the disclosed embodiment of the invention as well as other embodiment thereof may occur to those skilled in the art. Accordingly, the appended claims are intended to cover all embodiments which do not depart from the spirit and scope of the invention.

I claim:

1. An illuminating apparatus for an exhaust tail pipe comprising a lighting means screwed on a tail end of the exhaust tail pipe by means of a pipe clip, the lighting means having a body which houses a holding dock for holding an axle of a lighting wheel;
wherein the lighting wheel includes a left hub and a right hub corresponding to each other for housing a low speed generator, the low speed generator having a coil covered by a polar plate from outside and a magnet coupled on the axle, the polar plate having an outer peripheral rim connecting to a plurality of LED lamps, the right hub having an outer peripheral rim which has fan blades located thereon and an inner peripheral rim which has a first housing compartment for housing a bearing and a second housing compartment for housing the low speed generator and the LED lamps mounted onto the polar plate, the left hub being fixedly covered the housing compartments from outside thereof.

2. The illuminating apparatus for an exhaust tail pipe of claim 1, wherein the left hub is made from a transparent material.

3. The illuminating apparatus for an exhaust tail pipe of claim 1, wherein the pipe clip is fastened to the exhaust tail pipe, the pipe clip having a pair of flaps extending sidewards to engage with a screw for fastening, the pipe clip having an anchor hole to engage with a screw to fasten to a screw hole formed on one end of a connection beam, the connection beam having another end which has another screw hole to engage with another screw to fasten to a screw hole formed on the body of the lighting means.
